(19) United States
(12) Patent Application Publication
(10) Pub. No.: US 2026/0065668 A1
(43) Pub. Date: Mar. 5, 2026

(54) SNOW REMOVAL SUPPORT SYSTEM, SNOW REMOVAL SUPPORT METHOD, AND RECORDING MEDIUM

(71) Applicant: NEC CORPORATION, Minato-ku, Tokyo (JP)

(72) Inventors: Yoshihiro NISHIKAWA, Tokyo (JP); Chisato SUGAWARA, Tokyo (JP); Yusuke MIZUKOSHI, Tokyo (JP); Yuta SHIMIZU, Tokyo (JP)

(73) Assignee: NEC CORPORATION, Minato-ku, Tokyo (JP)

(21) Appl. No.: 19/105,128

(22) PCT Filed: Sep. 26, 2022
(86) PCT No.: PCT/JP2022/035604

§ 371 Date: Feb. 20, 2025

(51) Int. Cl. G06V 20/10; G06Q 50/26; G06V 10/764

(52) U.S. Cl. CPC G06V 20/10; G06Q 50/265; G06V 10/764

(57) ABSTRACT

This snow removal support system comprises an acquisition unit, an identification unit, an estimation unit and an output unit. The acquisition unit acquires an image with depicts a road on which snow has accumulated, and measurement data which measures the state of travel of a vehicle traveling the road on which snow has accumulated. The identification unit identifies the state of the snow surface on the basis of the image which depicts the road on which snow has accumulated. The estimation unit estimates the priority for snow removal at each point along the road on the basis of the identified snow surface state and the measurement data. The output unit outputs the estimated snow removal priority.

### TECHNICAL FIELD

The present invention relates to a snow removal support system and the like.

### BACKGROUND ART

At the time of snowfall, the road manager grasps the state of the snow surface on the road by, for example, patrol by the vehicle. Then, the road manager determines whether snow removal is necessary based on the state of the snow surface, and dispatches a snow removing vehicle to a place where snow removal is necessary. On the other hand, for example, when there is a limit to the number of snow removing vehicles or the number of workers, the road manager needs to determine a point where priority of snow removal is high from a large number of points on the road to be managed. Therefore, it is desirable to have a system capable of supporting confirmation of the state of the snow surface on the road and determination of necessity of snow removal.

The road surface determination method of PTL 1 detects a boundary of a region where a height of a road surface changes based on a radio wave image based on an electromagnetic wave emitted from an object existing around a vehicle, and determines a state of the road surface.

A transportation and snow clearing planning support system of PTL 2 calculates a snow amount of a transportation and snow clearing target based on a satellite image.

### CITATION LIST

### Patent Literature

PTL 1: JP 2018-84535 A
PTL 2: JP 2012-203495 A

### SUMMARY OF INVENTION

### Technical Problem

In the road surface determination method of PTL 1 and the transportation and snow clearing planning support system of PTL 2, it may be difficult to determine a point where a priority of snow removal is high.

In order to solve the above problem, an object is to provide a snow removal support system and the like capable of easily estimating a point where a priority of snow removal is high on a road.

### Solution to Problem

In order to solve the above problems, a snow removal support system of the present invention includes an acquisition means for acquiring an image obtained by photographing a snow accumulated road and measurement data obtained by measuring a traveling state of a vehicle traveling on the snow accumulated road, an identification means for identifying a state of a snow surface from the image obtained by photographing the snow accumulated road, an estimation means for estimating a priority of snow removal at each point along a road based on the identified state of the snow surface and the measurement data, and an output means for outputting the estimated priority of snow removal.

A snow removal support method of the present invention includes acquiring an image obtained by photographing a snow accumulated road and measurement data obtained by measuring a traveling state of a vehicle traveling on the snow accumulated road, identifying a state of a snow surface from the image obtained by photographing the snow accumulated road, estimating a priority of snow removal at each point along a road based on the identified state of the snow surface and the measurement data, and outputting the estimated priority of snow removal.

A non-transitory recording medium of the present invention records a snow removal support program for causing a computer to execute a process of acquiring an image obtained by photographing a snow accumulated road and measurement data obtained by measuring a traveling state of a vehicle traveling on the snow accumulated road, a process of identifying a state of a snow surface from the image obtained by photographing the snow accumulated road, a process of estimating a priority of snow removal at each point along a road based on the identified state of the snow surface and the measurement data, and a process of outputting the estimated priority of snow removal.

### Advantageous Effects of Invention

According to the present invention, a point where a priority of snow removal is high can be easily estimated on a road.

### BRIEF DESCRIPTION OF DRAWINGS

FIG. 1 is a diagram illustrating an example of a configuration according to an example embodiment of the present invention.

FIG. 2 is a diagram schematically illustrating an example of photographing a road and measuring a traveling state of a vehicle by traveling of the vehicle.

FIG. 3 is a diagram illustrating an example of a configuration of a snow removal support system according to the example embodiment of the present invention.

FIG. 4 is a diagram illustrating an example of a display screen according to the example embodiment of the present invention.

FIG. 5 is a diagram illustrating an example of a display screen according to the example embodiment of the present invention.

FIG. 6 is a diagram illustrating an example of a display screen according to the example embodiment of the present invention.

FIG. 7 is a diagram illustrating an example of a display screen according to the example embodiment of the present invention.

FIG. 8 is a diagram illustrating an example of a display screen according to the example embodiment of the present invention.

FIG. 9 is a diagram illustrating an example of an operation flow of the snow removal support system according to the example embodiment of the present invention.

FIG. 10 is a diagram illustrating an example of another configuration of the present invention.

### EXAMPLE EMBODIMENT

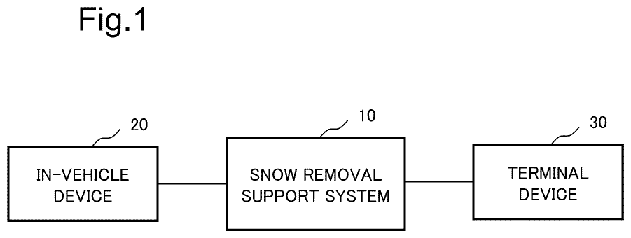

An example embodiment of the present invention will be described in detail with reference to the drawings. FIG. 1 is a diagram illustrating an example of a configuration of a road management system according to an example embodiment of the present invention. The road management system includes a snow removal support system 10, an in-vehicle device 20, and a terminal device 30. The snow removal support system 10 is connected to the in-vehicle device 20 via, for example, a network. The input/output of data between the snow removal support system 10 and the in-vehicle device 20 may be performed via a storage device. For example, the input/output of data between the snow removal support system 10 and the in-vehicle device 20 may be performed via a nonvolatile semiconductor storage device. Furthermore, the snow removal support system 10 is connected to the terminal device 30 via a network. A plurality of in-vehicle devices 20 and a plurality of terminal devices 30 may be provided.

The snow removal support system 10 is, for example, a system for estimating the priority of snow removal at each point along a road at the time of snowfall. For example, the road manager performs snow removal on the road based on the estimation result of the snow removal support system 10.

The snow removal support system 10 identifies the state of the snow surface from, for example, an image obtained by photographing a snow accumulated road. The snow removal support system 10 then estimates the priority of snow removal at each point along the road based on the identified state of the snow surface and the measurement data obtained by measuring the traveling state of the vehicle traveling on the snow accumulated road. The vehicle is, for example, an automobile. The vehicle may be a motorcycle such as a motorcycle and a scooter. Furthermore, the vehicle may be a bicycle. The vehicle is not limited to the above.

The priority of snow removal is, for example, an index indicating the extent at which snow removal is necessary. When the priority of snow removal is high, this means, for example, that the extent at which the snow removal is required is higher than other points. The necessity of snow removal means, for example, that snow removal is necessary for smooth and safe passing of a vehicle. The point where the priority of snow removal is high is, for example, a point where there is a high possibility that a problem or danger occurs in the passing of the vehicle due to snow on the road surface. The point where the priority of snow removal is high is, for example, a point where there is a high possibility that a problem or danger occurs in the passing of a pedestrian due to snow on the road surface.

The occurrence of problem in passing means, for example, occurrence of a state in which passing cannot be performed due to snow on the road surface. Furthermore, the occurrence of problem in passing means, for example, that the time required for passing becomes longer than when there is no snow. The occurrence of danger in passing means, for example, that an accident occurs due to snow on the road surface.

The priority of snow removal is set to be higher, for example, the higher the state of the snow surface possibly affecting the passing and safety of the vehicle. The state of the snow surface is, for example, the state of snow on a road surface of a road when snow is accumulated on the road. The state of the snow surface is, for example, the state of snow on a traveling surface of a vehicle when snow is accumulated on the road. The state of the snow surface is, for example, the state of snow accumulated on a road surface of a road at a passing portion of a vehicle on the road. The passing portion of the vehicle may include a portion where the vehicle may pass. For example, the passing portion of the vehicle may include a center line, a lane boundary line, a shoulder, a side strip, and a guiding band.

The priority of snow removal may be set to be higher the higher the state of the snow surface possibly affecting the passing and safety of the pedestrian. In this case, the state of the snow surface may include the state of snow on the sidewalk of the road.

The state of the snow surface is, for example, one or a plurality of the snow accumulation amount, the width of the rut generated on the snow surface, the step difference of the rut generated on the snow surface, the interval of the ruts generated on the snow surface, the presence or absence of snow freezing, the presence or absence of snow melting, and the passable width.

When the state of the snow surface includes the snow accumulation amount, the priority of snow removal is set to be higher, for example, the greater the snow accumulation amount. In addition, when the state of the snow surface includes the step difference of a rut generated on the snow surface, the priority of snow removal is set to be higher, for example, the greater the width and the step difference of the rut generated on the snow surface.

The priority of snow removal may be set to be high at a point where the importance of passing is high. In addition, the priority of snow removal may be set to be high at a point where the possibility that danger occurs in passing is high. The point where the importance of passing is high is, for example, a point on a main road where the traffic volume is large. The point where the importance of passing is high may be, for example, a point where a hospital, a police station, and a fire department are present nearby where emergency vehicles frequently pass. The point where the importance of passing is high is not limited to the above.

The point where the possibility that danger occurs in passing is high is, for example, an intersection where stop and start of vehicles are frequently performed and where the state of the snow surface tends to change easily, and near the crossing. The point where the possibility that danger occurs in passing is high may be a bridge and an entrance/exit of a tunnel. The point where the possibility that danger occurs in passing is high is not limited to the above.

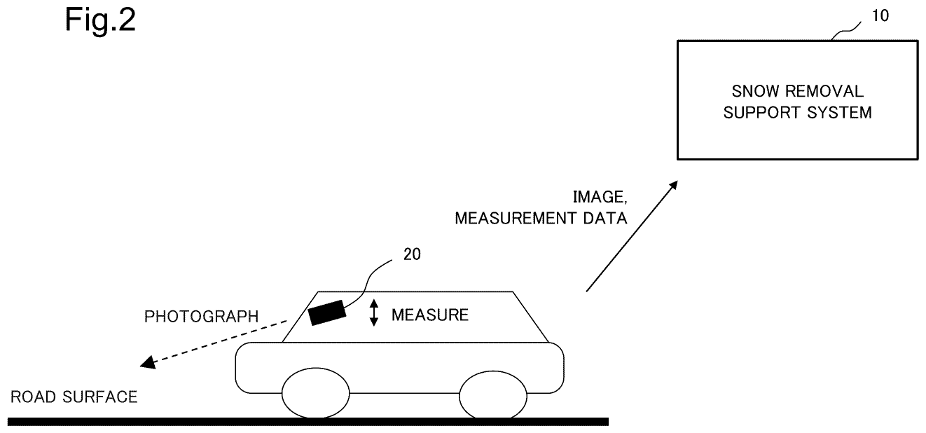

FIG. 2 is a diagram schematically illustrating an example of photographing a road and measuring a traveling state of a vehicle by traveling of the vehicle. In the example of FIG. 2, the in-vehicle device 20 is mounted on the vehicle. The in-vehicle device 20 photographs a road surface at the time of traveling on the road by, for example, a photographing device. Furthermore, the in-vehicle device 20 measures the traveling state of the vehicle by, for example, a sensor for measuring the traveling state of the vehicle. Then, the in-vehicle device 20 outputs the photographed image and the measurement data to, for example, the snow removal support system 10.

The sensor for measuring the traveling state of the vehicle is, for example, an acceleration sensor. The in-vehicle device 20 includes, for example, an acceleration sensor capable of measuring acceleration in the vertical direction of the vehicle. The acceleration sensor capable of measuring acceleration in the vertical direction of the vehicle can measure, for example, vibration in the vertical direction of the vehicle. Furthermore, the acceleration sensor may measure acceleration in an advancing direction of the vehicle and a direction orthogonal to the advancing direction and the vertical direction of the vehicle. The vertical direction of the vehicle is a direction perpendicular to the road surface of the road. That is, the vertical direction of the vehicle is a direction perpendicular to the traveling surface. Moreover, the direction orthogonal to the advancing direction and the vertical direction of the vehicle is a vehicle width direction. The sensor for measuring the traveling state of the vehicle is not limited to the acceleration sensor.

The acceleration in the vertical direction of the vehicle changes, for example, by vibration in the vertical direction of the vehicle. The vibration in the vertical direction of the vehicle is generated by, for example, a step difference of the traveling surface. The vibration in the vertical direction of the vehicle is generated, for example, by a step difference of a rut generated on a snow surface. Therefore, the acceleration in the vertical direction of the vehicle can reflect the state of the snow surface. The measurement data obtained by measuring the traveling state of the vehicle is not limited to the acceleration in the vertical direction of the vehicle.

For example, the snow removal support system 10 identifies the state of the snow surface shown in the image acquired from the in-vehicle device 20. The snow removal support system 10 estimates the priority of snow removal at each point along the road based on the state of the snow surface obtained by identification of the image and the state of the snow surface obtained from the measurement data. Then, the snow removal support system 10 outputs the estimation result of the priority of snow removal to, for example, the terminal device 30. The manager of the road performs snow removal of the road with reference to, for example, the estimation result of the priority of snow removal.

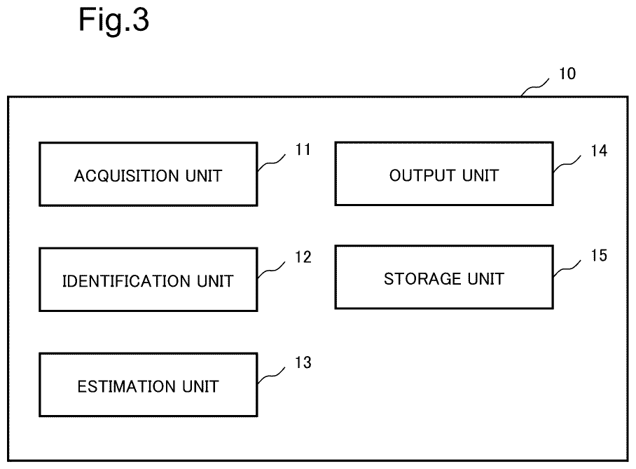

Here, a configuration of the snow removal support system 10 will be described. FIG. 3 is a diagram illustrating an example of a configuration of the snow removal support system 10 according to the example embodiment of the present invention.

The snow removal support system 10 includes an acquisition unit 11, an identification unit 12, an estimation unit 13, and an output unit 14 as a basic configuration. The snow removal support system 10 further includes, for example, a storage unit 15.

The acquisition unit 11 acquires an image obtained by photographing a snow accumulated road and measurement data obtained by measuring a traveling state of a vehicle traveling on the snow accumulated road. For example, information on a photographed point is added to the image obtained by photographing the snow accumulated road and the measurement data obtained by measuring the traveling state of the vehicle. Information on a photographed date and time may be added to the image obtained by photographing the road, the image obtained by photographing the snow accumulated road and the measurement data obtained by measuring the traveling state of the vehicle.

For example, the acquisition unit 11 acquires, from the in-vehicle device 20, the image obtained by photographing the snow accumulated road and the measurement data obtained by measuring the traveling state of the vehicle traveling on the snow accumulated road. For example, the acquisition unit 11 acquires, from the in-vehicle device 20, the image obtained by photographing the snow accumulated road and the measurement data obtained by measuring the traveling state of the vehicle traveling on the snow accumulated road via the network. For example, the acquisition unit 11 acquires, from the in-vehicle device 20, the image obtained by photographing the snow accumulated road and the measurement data obtained by measuring the traveling state of the vehicle traveling on the snow accumulated road via the storage device. As the storage device, for example, a nonvolatile semiconductor storage device can be used. The storage device is not limited to a nonvolatile semiconductor storage device. The acquisition unit 11 may acquire, from a server connected via the network, the image obtained by photographing the snow accumulated road and the measurement data obtained by measuring the traveling state of the vehicle traveling on the snow accumulated road via the storage device. For example, the acquisition unit 11 saves, in the storage unit 15, the image obtained by photographing the snow accumulated road and the measurement data obtained by measuring the traveling state of the vehicle traveling on the snow accumulated road.

The acquisition unit 11 may acquire the image obtained by photographing a snow accumulated road from a roadside camera. When acquiring the image obtained by photographing a snow accumulated road from a roadside camera, the acquisition unit 11 acquires, for example, the measurement data obtained by measuring the traveling state of the vehicle traveling on the snow accumulated road from the in-vehicle device 20.

The acquisition unit 11 may acquire information used for estimating the priority of snow removal from a server connected via the network. The information used for estimating the priority of snow removal is information that affects the estimation of the priority of snow removal. The acquisition unit 11 acquires, for example, weather information. The acquisition unit 11 acquires, for example, map data. The map data may include data related to topography and structure of a road. Furthermore, the acquisition unit 11 may acquire information regarding the importance of the road, the traffic volume, the implementation plan of an event, and the surrounding facilities. The information used for estimating the priority of snow removal may be input to the snow removal support system 10 or the terminal device 30 by the worker. When input to the terminal device 30, the acquisition unit 11 acquires, from the terminal device 30, information used for estimating the priority of snow removal.

The acquisition unit 11 may acquire the selection of a range for estimating the priority of snow removal from the terminal device 30. The selection of the range for estimating the priority of snow removal is made in the terminal device 30 by, for example, the operation of the worker.

The identification unit 12 identifies the state of the snow surface from the image obtained by photographing the snow accumulated road. For example, the identification unit 12 identifies the state of the snow surface from the image obtained by photographing the snow accumulated road using an identification model. The identification model identifies the state of the snow surface by, for example, image recognition. When the state of the snow surface is a state of a rut, the identification model identifies, for example, the width of the rut on the snow surface. The identification model may identify a passable width of the road. In addition, the identification model may identify a snow accumulation amount. The identification model identifies the snow accumulation amount based on, for example, a height of a portion where a structure on the road is buried in snow. The identification model identifies the snow accumulation amount based on, for example, a height of a portion where a pole indicating a road width is buried in snow. When the poles indicating the road width are painted in different colors for each set height, the identification model may estimate the height of a portion buried in snow from the color of the pole appearing on the snow surface, and identify the snow accumulation amount based on the estimated height. The identification model may identify the presence or absence of snow freezing on the road surface of the road.

The identification model is generated, for example, by machine learning. The identification model is generated, for example, by deep learning using a neural network. The identification model is generated, for example, by learning the relationship between the image showing the snow surface and the state of the snow surface. The identification model is generated, for example, in a system outside the snow removal support system 10.

The estimation unit 13 estimates the priority of snow removal at each point along the road based on the state of the snow surface identified by the identification unit 12 and the measurement data. The estimation unit 13 estimates the priority of snow removal using, for example, a score based on the state of the snow surface identified by the identification unit 12 and a score based on the measurement data of the traveling state of the vehicle.

For example, the estimation unit 13 estimates the score of the state of the snow surface based on the state of the snow surface identified by the identification unit 12. The score of the state of the snow surface is, for example, an index indicating the poor state of the snow surface. The poor state of the snow surface means, for example, that the state of snow on the road is a state in which the necessity for snow removal is high. That is, the score of the state of the snow surface takes a higher value, for example, the higher the priority of snow removal. The estimation unit 13 estimates the score of the state of the snow surface identified by the identification unit 12 based on, for example, the set reference. The reference for estimating the score of the state of the snow surface is set, for example, such that the score becomes higher as the state of the snow surface becomes closer to a state in which the necessity for snow removal becomes higher. The reference for estimating the score of the state of the snow surface is set based on, for example, the classification of the state of the snow surface and the degree of the state of the snow surface. When the classification of the state of the snow surface is a rut, the degree of the state of the snow surface is, for example, a width of the rut. When the classification of the state of the snow surface is a rut, the reference for estimating the score indicating the state of the snow surface is set such that, for example, the score becomes higher as the width of the rut becomes wider.

Furthermore, the estimation unit 13 estimates the score of the measurement data based on, for example, the measurement data of the traveling state of the vehicle and the set reference. The score of the measurement data is, for example, an index indicating the influence of the state of the snow surface on the traveling of the vehicle. The score of the measurement data is, for example, an index indicating the influence of the poor state of the snow surface on the traveling of the vehicle. The reference used when the score is estimated from the measurement data is set such that, for example, the score becomes higher as the influence of the state of the snow surface on the traveling of the vehicle becomes larger. The reference used when the score is estimated from the measurement data is set such that, for example, the score becomes higher as the acceleration becomes larger. When the measurement data is acceleration in the vertical direction of the vehicle, the score estimated from the measurement data indicates, for example, a step difference in the height direction of a step difference generated on the snow surface. Furthermore, when the measurement data is acceleration in the advancing direction of the vehicle, the score estimated from the measurement data indicates, for example, a frozen state and a molten state of the snow surface. The step difference generated on the snow surface is, for example, due to a rut generated on the snow surface. The reference used when the score is estimated from the measurement data may be set such that the score becomes higher as the change in acceleration becomes larger.

The estimation unit 13 estimates the priority of snow removal based on the state of the snow surface and the measurement data. For example, the estimation unit 13 sets the sum of the score of the state of the snow surface and the score of the measurement data as the priority of snow removal. The priority of snow removal is not limited to the sum of the score of the state of the snow surface and the score of the measurement data. The estimation unit 13 may estimate the priority of snow removal using values obtained by weighting the score of the state of the snow surface and the score of the measurement data. Furthermore, the estimation unit 13 may estimate the priority of snow removal using a value obtained by weighting one of the score of the state of the snow surface and the score of the measurement data. The estimation unit 13 may estimate the priority of snow removal using a value obtained by weighting the score estimated for each classification of the state of the snow surface.

The estimation unit 13 may further use the importance of the road to estimate the priority of snow removal. The estimation unit 13 scores the importance of the road based on, for example, the set reference. Then, for example, the estimation unit 13 sets the sum of the score estimated from the state of the snow surface, the score estimated from the measurement data, and the score estimated from the importance of the road as the priority of snow removal. The estimation unit 13 may estimate the priority of snow removal using a score estimated from the importance of the road as a weight. The score of the importance of the road is, for example, an index indicating the necessity of snow removal according to the priority of the road. For example, the necessity of snow removal becomes higher the higher the importance of the road. The reference used when the priority of snow removal is estimated based on the importance of the road is set such that, for example, the priority of snow removal becomes higher the higher the importance of the road. The importance of the road is, for example, an index indicating the importance in traffic. The importance of the road is set to be higher as the influence on the distribution of goods and flow of people becomes larger, for example, in a case where the road cannot be passed. The importance of the road is set to be high, for example, in a main road. In addition, the importance of the road may be set to be high on a road without a detour.

The estimation unit 13 may estimate the priority of snow removal by further using information regarding the topography at each point along the road. For example, the estimation unit 13 scores the topography at each point along the road based on, for example, the set reference. Then, for example, the estimation unit 13 sets the sum of the score estimated from the state of the snow surface, the score estimated from the measurement data, and the score of the topography at each point along the road as the priority of snow removal. The estimation unit 13 may estimate the priority of snow removal using the score of the topography at each point along the road as a weight. The score of the topography is, for example, an index indicating the influence of the topography around the road on the deterioration of the state of the snow surface. For example, the score of the topography is higher the larger the influence on the deterioration of the state of the snow surface. For example, the estimation unit 13 estimates the priority of snow removal using a reference in which the priority of snow removal becomes higher for a topography where the state of the snow surface is more likely to deteriorate. The topography where the state of the snow surface is likely to deteriorate is, for example, a topography where snow is likely to gather due to wind. The topography where the state of the snow surface is likely to deteriorate may be a topography that is shaded even in the daytime and snow is less likely to melt.

The estimation unit 13 may estimate the priority of snow removal by further using information regarding the structure at each point along the road. For example, the estimation unit 13 scores the structure at each point along the road based on, for example, the set reference. Then, for example, the estimation unit 13 sets the sum of the score estimated from the state of the snow surface, the score estimated from the measurement data, and the score of the structure at each point along the road as the priority of snow removal. The estimation unit 13 may estimate the priority of snow removal using the score of the structure at each point along the road as a weight. The score of the structure is, for example, an index indicating the influence of the structure of the road on the deterioration of the state of the snow surface. For example, the score of the topography is higher the larger the influence on the deterioration of the state of the snow surface. For example, the estimation unit 13 estimates the priority of snow removal using a reference in which the priority of snow removal becomes higher for a structure in which the state of the snow surface is more likely to deteriorate. The structure in which the state of the snow surface is likely to deteriorate may be, for example, a portion where the force of the tire applied to the road surface is large. The structure in which the state of the snow surface is likely to deteriorate is, for example, a bridge, an entrance/exit of a tunnel, an intersection, a junction, a divergence, and a slope. At the portion of a structure where the state of the snow surface is likely to deteriorate, the state of the snow surface is likely to deteriorate due to, for example, start, stop, and lane change of the vehicle. The structure in which the state of the snow surface is likely to deteriorate is not limited to the above.

The estimation unit 13 may estimate the priority of snow removal by further using information regarding surrounding facilities at each point along the road. For example, the estimation unit 13 scores the surrounding facilities at each point along the road based on, for example, the set reference. Then, for example, the estimation unit 13 sets the sum of the score estimated from the state of the snow surface, the score estimated from the measurement data, and the score of the surrounding facilities at each point along the road as the priority of snow removal. The estimation unit 13 may estimate the priority of snow removal using the score of the surrounding facilities at each point along the road as a weight. The score of the surrounding facilities is, for example, an index indicating the necessity of snow removal according to the type of the surrounding facilities. For example, the necessity of snow removal becomes higher the higher the importance of the surrounding facilities. The estimation unit 13 estimates the priority of snow removal using a reference in which the priority of snow removal becomes high, for example, in a case where important surrounding facilities exist. The important surrounding facilities are, for example, facilities that greatly affect life and safety due to snow accumulation when not available. The important surrounding facilities are, for example, schools, nursery schools, kindergartens, hospitals, police stations, fire departments, stations, bus terminals, harbors, industrial parks, and distribution parks. The important surrounding facilities are surrounding facility not limited to the above.

The estimation unit 13 may estimate the priority of snow removal by further using a report from a citizen. The citizen may include a driver. For example, the estimation unit 13 estimates the priority of snow removal in such a way that the priority of snow removal at a point where a citizen has reported the necessity of snow removal becomes high.

The estimation unit 13 may estimate the priority of snow removal based on the state of the snow surface predicted using the data of weather forecast. For example, the estimation unit 13 predicts the state of the snow surface at the scheduled time when the snow removal is to be performed using the data of weather forecast. Then, the estimation unit 13 estimates the priority of snow removal based on the result of prediction. The estimation unit 13 may estimate the priority of snow removal based on the prediction of the state of the snow surface for each time zone.

For example, the estimation unit 13 predicts a snowfall amount using the data of weather forecast, and predicts the state of the snow surface based on the predicted snowfall amount. Furthermore, the estimation unit 13 may predict the state of the snow surface based on the prediction results of the wind speed, the wind direction, the rainfall amount, and the air temperature. The wind speed and the wind direction are used, for example, for prediction of a snowdrift due to the influence of wind. For example, the estimation unit 13 predicts a width and a depth of a rut on the snow surface using data of weather forecast. The estimation unit 13 predicts a width and a depth of a rut on the snow surface using, for example, the snowfall amount and the air temperature. Furthermore, for example, the estimation unit 13 may predict the state of the snow surface using the traffic volume for each time zone in addition to the data of weather forecast.

The estimation unit 13 may estimate the priority of snow removal by further using a road surface state of when there is no snow accumulation. The estimation unit 13 estimates the priority of snow removal by further using, for example, the deterioration degree of the road surface diagnosed when there is no snow accumulation. For example, the estimation unit 13 estimates the priority of snow removal in such a way that the priority of snow removal at a point where the deterioration degree is equal to or more than a reference becomes low. The estimation unit 13 estimates the priority of snow removal by, for example, multiplying the score estimated from the state of the snow surface and the measurement data by a coefficient less than 1 at a point where the deterioration degree is equal to or more than the reference. The estimation unit 13 may estimate the priority of snow removal by, for example, multiplying the score estimated from the state of the snow surface and the measurement data by a coefficient of less than 1 that decreases as the deterioration degree increases. For example, the advancement in the deterioration of the road surface due to snow removal can be suppressed by estimating the priority of snow removal in such a way that the priority of snow removal at a point where the deterioration degree is equal to or more than the reference becomes low. The advancement in the deterioration of the road surface due to snow removal occurs, for example, by contact of a tool for snow removal with the road surface. In addition, the estimation unit 13 may exclude a point where the deterioration degree of the road surface is equal to or more than the reference from a target for estimating the priority of snow removal.

The deterioration of the road surface is, for example, one or a plurality of cracks, ruts, potholes, and flatness abnormalities generated on the road surface. The deterioration of the road surface is not limited to the above. When the deterioration of the road surface is a crack, the deterioration degree of the road surface is, for example, a crack rate. The crack rate is, for example, a value indicating a ratio between an area of deterioration included in an image photographed at a certain point and an area of a road included in the image. When the deterioration of the road surface is a rut, the deterioration degree is, for example, a rut amount. Furthermore, when the deterioration of the road surface is the flatness abnormality, for example, an international roughness index (IRI) is used as the deterioration degree. IRI is an index indicating flatness of a road. The IRI may be calculated based on the acceleration in the vertical direction of the vehicle. The measurement value of the acceleration in the vertical direction reflects, for example, vibration of the vehicle in the vertical direction when the vehicle passes through a rut. The acceleration in the vertical direction is measured by, for example, an acceleration sensor attached to the vehicle. In addition, a maintenance control index (MCI) may be used as the deterioration degree. The MCI is, for example, a composite deterioration index calculated from the crack rate, the rut amount, and the flatness.

The estimation unit 13 may estimate the priority of snow removal by using an estimation model for estimating the priority of snow removal. The estimation model estimates the priority of snow removal based on, for example, the state of the snow surface and the measurement data. The estimation model is, for example, a learning model that outputs an estimation result of the priority of snow removal with the state of the snow surface and the measurement data as inputs.

The estimation model may estimate the priority of snow removal by further using weather forecast data as an input. The estimation model may estimate the priority of snow removal by further using the importance of road as an input. In addition, the estimation model may estimate the priority of snow removal by further using the topography and structure at each point along the road as inputs. The input of the estimation model is not limited to the above.

The estimation model is generated, for example, in an external system of the snow removal support system 10. The estimation model is generated, for example, by learning the relationship between the state of the snow surface, the measurement data, and the presence or absence of snow removal in the past. When data other than the state of the snow surface and the measurement data is input, for example, data other than the state of the snow surface and the measurement data is also used as the learning data.

The estimation model is generated, for example, by deep learning using a neural network. The estimation model is generated, for example, by learning the relationship of the states of the snow surface and the relationship of the measurement data of the vehicle traveling state and the presence or absence of snow removal at the time of past snowfall. The estimation model is generated, for example, by training a neural network using the state of the snow surface identified by the identification unit 12 and the measurement data as input data and the presence or absence of snow removal as a label. The state of the snow surface used as the input data is, for example, the classification of the state of the snow surface identified by the identification unit 12 and the degree of the state of the snow surface. The classification of the state of the snow surface and the degree of the state of the snow surface are converted into, for example, feature amounts and input to the neural network. Even when data other than the relationship of the states of the snow surface and the measurement data of the vehicle traveling state is used as the input data, for example, each piece of data is converted into a feature amount and input to the neural network. The estimation model thus generated estimates the probability that snow removal is necessary, for example, based on the input data. The estimation model outputs, for example, a probability that snow removal is necessary as a priority of snow removal.

The estimation model may be generated using a machine learning algorithm based on factorized asymptotic Bayesian inference. When learning is performed using a machine learning algorithm based on factorized asymptotic Bayesian inference, classification is performed according to a rule in a decision tree form using the state of the snow surface identified by the identification unit 12 and the measurement data as input data and the presence or absence of snow removal as a label. Then, an estimation model for estimating the priority of snow removal is generated using a linear model in which different explanatory variables are combined for each case. A learned estimation model is generated by sequentially performing processes of optimization of a data classification condition, generation of an estimation model by optimization of a combination of explanatory variables, and deletion of an unnecessary estimation model using the generated estimation model. In addition, the estimation model generated using the machine learning algorithm based on the factorized asymptotic Bayesian inference can output an estimation reason of the priority of snow removal.

When the factorized asymptotic Bayesian inference is used as the basis, the estimation model outputs the estimation reason of the priority of snow removal based on, for example, the weight of the explanatory variable included in the linear model used for the estimation of the priority of snow removal. The estimation model may output an estimation reason of the priority of snow removal based on a variation in an estimation result of the priority of snow removal in a case where each item of the input data is changed. For example, in a case where each item of the input data is changed, the estimation model outputs an item in which the variation in the estimation result of the priority of snow removal is larger than that of other items as the estimation reason of the priority of snow removal. The machine learning algorithm used for generating the estimation model is not limited to the above.

The output unit 14 outputs the priority of snow removal estimated by the estimation unit 13. The output unit 14 outputs, for example, the priority of snow removal to the terminal device 30. The output unit 14 may output the priority of snow removal to a display device (not illustrated) connected to the snow removal support system 10.

For example, the output unit 14 superimposes and outputs the priority of snow removal on a map. For example, the output unit 14 superimposes and outputs a numerical value indicating the priority of snow removal at each point on a map. The output unit 14 may superimpose and output the stage of the priority of snow removal at each point on the map. The stage of the priority of snow removal indicates, for example, in which stage of a plurality of stages divided for each numerical band the priority of snow removal estimated by the estimation unit 13 is included.

The output unit 14 may output the estimation result of the priority of snow removal by setting the color of the road on the map to be different for each stage of the priority of snow removal. Furthermore, the output unit 14 may set the estimation result of the priority of snow removal as a list of priorities of snow removal for each point. The output form of the estimation result of the priority of snow removal is not limited to the above.

The output unit 14 may output an estimation reason of the priority of snow removal in addition to the priority of snow removal. The output unit 14 outputs, for example, an item having the highest contribution to the numerical value of the priority of snow removal as an estimation reason of the priority of snow removal. The item having the highest contribution to the numerical value of the priority of snow removal is, for example, an item having the highest score among the items used for estimating the priority of snow removal. For example, when the score of the state of the snow surface is the highest, the output unit 14 outputs the classification of the snow surface as the estimation reason. In addition, in a case where an estimation model capable of outputting an estimation reason is used, the output unit 14 outputs the estimation reason by the estimation model as the estimation reason. For example, when the contribution to the estimation result of the state of the snow surface is large, the estimation model outputs the classification of the state of the snow surface as the estimation reason. When the contribution to the estimation result is large, this means, for example, that the weight of the variable used for estimation is large.

The output unit 14 may superimpose and output the estimation reason of the priority of snow removal on the map. The output unit 14 outputs the estimation reason by, for example, superimposing an icon set for each estimation reason on the map.

The output unit 14 may output a snow removal route generated based on the priority of snow removal. The output unit 14 generates, for example, a route passing through a point having a high priority of snow removal, and outputs the route as a snow removal route. The output unit 14 generates, for example, a route passing through a point of priority of snow removal of equal to or higher than a set reference, and outputs the route as a snow removal route.

The output unit 14 may output data related to a display screen used for selection of a range for estimating the priority of snow removal. The output unit 14, for example, outputs a map for selecting a range for estimating the priority of snow removal on the map to the terminal device 30.

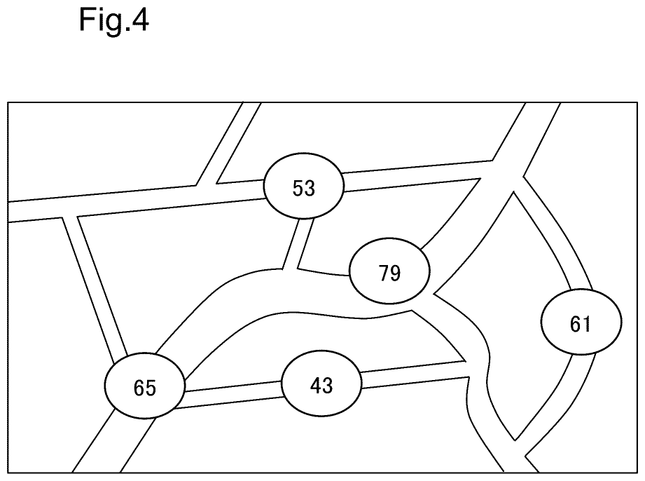

FIG. 4 is a diagram illustrating an example of a display screen displaying an estimation result of the priority of snow removal. In the example of the display screen of FIG. 4, the priority of snow removal is superimposed and displayed on the map. In the example of the display screen of FIG. 4, the numerical value indicating priority of snow removal is displayed on the map.

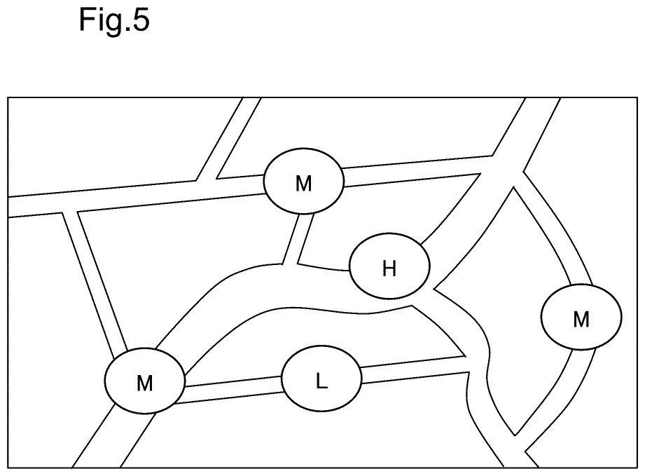

FIG. 5 is a diagram illustrating an example of a display screen displaying the estimation result of the priority of snow removal according to the stages of the priority of snow removal set in a plurality of stages. In the example of the display screen of FIG. 5, the priority of snow removal is set in three stages of “H”, “M”, and “L”. In the example of the display screen of FIG. 5, for example, the priority of snow removal at the point of “H” is the highest, and the priority of snow removal at the point of “L” is the lowest. The priority of snow removal may be set in stages other than the three stages. In addition, the display form of the priority of snow removal in the case of indicating the priority of snow removal by stages is not limited to the example of the display screen of FIG. 5.

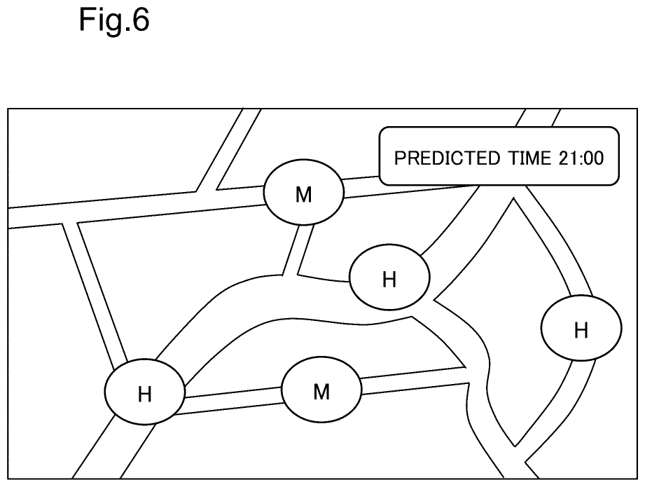

FIG. 6 is a diagram illustrating an example of a display screen displaying the priority of snow removal at a set time. In the example of the display screen of FIG. 6, similarly to FIG. 5, the estimation result of the priority of snow removal is displayed by the stage of the priority of snow removal set in a plurality of stages. In the example of the display screen of FIG. 6, the set time is displayed as “predicted time 21:00”. The example of the display screen of FIG. 6 is used, for example, when the priority of snow removal is estimated by predicting the state of the snow surface at a time later than the time of estimation based on the data of weather forecast. The example of the display screen of FIG. 6 illustrates, for example, a result of estimating the priority of snow removal by predicting the state of the snow surface at 21:00.

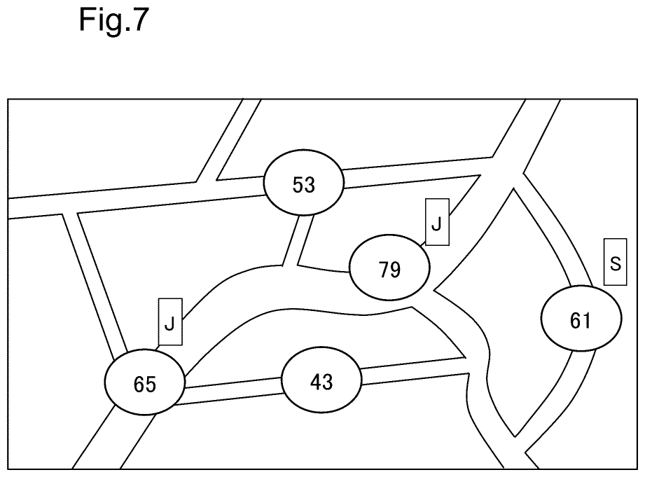

FIG. 7 illustrates an example of a display screen for outputting an estimation reason in addition to the estimation result of the priority of snow removal. In the example of the display screen of FIG. 7, the estimation reason is indicated by an alphabet for a point where the priority of snow removal is equal to or higher than the reference. In the example of the display screen of FIG. 7, “J” indicates that the reason the priority of snow removal is high is the intersection. In the example of the display screen of FIG. 7, “S” indicates that the reason the priority of snow removal is high is that the road is a slope. The display of reason in the case of displaying the estimation reason of the priority of snow removal is not limited to the example of the display screen of FIG. 7. In addition, the estimation reason of the priority of snow removal may be displayed for all the points where the priority of snow removal has been estimated.

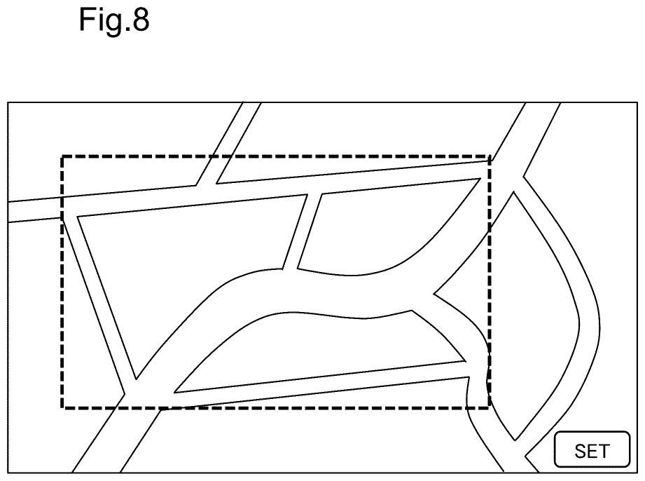

FIG. 8 is a diagram illustrating an example of a display screen for selecting a range for estimating the priority of snow removal. In the example of the display screen of FIG. 8, selection of a range for estimating the priority of snow removal is performed by selecting a range with a broken line frame on the map. The range for estimating the priority of snow removal is selected by a mouse operation of a worker in, for example, the terminal device 30. Then, the terminal device 30 outputs the selected range for estimating the priority of snow removal to the snow removal support system 10. For example, the estimation unit 13 estimates the priority of snow removal on a road within the selected range. In addition, the range for estimating the priority of snow removal may be selected by designating each point on the map. Furthermore, the selection of the range for estimating the priority of snow removal is not limited to a rectangle, and may be performed in an arbitrary shape.

The storage unit 15 saves, for example, data used for estimating the priority of snow removal. The storage unit 15 saves, for example, map data regarding roads in a target region for snow removal. The map data may include data related to topography and road structures. The storage unit 15 may save data of importance of a road. The storage unit 15 may save the data of weather forecast. In addition, the storage unit 15 may save an image obtained by photographing a road and measurement data of a traveling state of a vehicle. In addition, the storage unit 15 may save the state of the snow surface identified by the identification unit 12.

The storage unit 15 saves, for example, a reference used for estimating the priority of snow removal. The storage unit 15 saves the reference used for estimating, for example, the score of the state of the snow surface and the score of the measurement data. In addition, the storage unit 15 may save a reference used for scoring the importance of the road, the topography, and the structure of the road.

When the priority of snow removal is estimated using the estimation model, the storage unit 15 saves, for example, the estimation model. The estimation model may be saved in a storage means other than the storage unit 15.

The in-vehicle device 20 includes, for example, a photographing device for photographing the front side of the vehicle. The photographing device of the in-vehicle device 20 photographs an image including a road surface of a road. The photographing device of the in-vehicle device 20 may photograph the rear side of the vehicle. The in-vehicle device 20 adds, for example, information of a position where the image is photographed to the photographed image. The in-vehicle device 20 specifies the position of the vehicle when an image is photographed using, for example, a global navigation satellite system (GNSS). The in-vehicle device 20 may specify the position of the vehicle based on a beacon including information of the position. The in-vehicle device 20 may specify the photographing point based on the travel distance from the point where the position of the vehicle is specified and the map information. Furthermore, the in-vehicle device 20 outputs the photographed image to, for example, the snow removal support system 10.

The in-vehicle device 20 includes a sensor for measuring a traveling state of the vehicle. The in-vehicle device 20 includes, for example, an acceleration sensor capable of measuring acceleration in the vertical direction of the vehicle. The vertical direction of the vehicle is a direction perpendicular to the traveling surface. In the acceleration sensor, the vertical direction of the vehicle is also referred to as a z-axis. Furthermore, the acceleration sensor may measure acceleration in an advancing direction of the vehicle and a direction orthogonal to the advancing direction and the vertical direction of the vehicle. The sensor for measuring the traveling state of the vehicle may be a sensor for measuring a load of a tire or a brake. Furthermore, the sensor for measuring the traveling state of the vehicle may be a sensor for measuring the speed of the vehicle. The sensor for measuring the traveling state of the vehicle is not limited to the above. Furthermore, the in-vehicle device 20 may acquire measurement data of the traveling state of the vehicle from the control device of the vehicle.

For example, the in-vehicle device 20 adds position information at the time of measurement to a measurement result by a sensor for measuring a traveling state of the vehicle. Then, the in-vehicle device 20 outputs a measurement result by the sensor to the snow removal support system 10 via, for example, a network. The in-vehicle device 20 may save measurement data of the traveling state of the vehicle in the storage device. The in-vehicle device 20 saves measurement data of the traveling state of the vehicle in, for example, a nonvolatile semiconductor storage device. The in-vehicle device 20 includes, for example, a slot to which a removable nonvolatile semiconductor storage device is mounted. As the nonvolatile semiconductor storage device, for example, a flash memory is used. The nonvolatile semiconductor storage device is not limited to a flash memory.

The in-vehicle device 20 is mounted on, for example, a vehicle for road monitoring traveled by a road manager. The in-vehicle device 20 may be mounted on a vehicle traveled by a person other than the road manager. For example, the in-vehicle device 20 may be mounted on a bus, a taxi, a truck, a public vehicle, a pick-up person, and an emergency vehicle. Furthermore, the in-vehicle device 20 may be mounted on a passenger car owned by an individual. The vehicle on which the vehicle device 20 is mounted is not limited to the above. Furthermore, as the in-vehicle device 20, for example, a drive recorder is used. The in-vehicle device 20 is not limited to a drive recorder.

The terminal device 30 acquires, for example, an estimation result of the priority of snow removal generated by the snow removal support system 10. Then, the terminal device 30 outputs the acquired estimation result of the priority of snow removal to a display device (not illustrated). Furthermore, the terminal device 30 may acquire a target range of snow removal input by an operation of a worker. The terminal device 30 outputs the acquired target range for snow removal to, for example, the snow removal support system 10.

As the terminal device 30, for example, a personal computer, a tablet computer, or a smartphone can be used. The terminal device 30 is not limited to the above example. Furthermore, the in-vehicle device 20 and the terminal device 30 may be an integrated device.

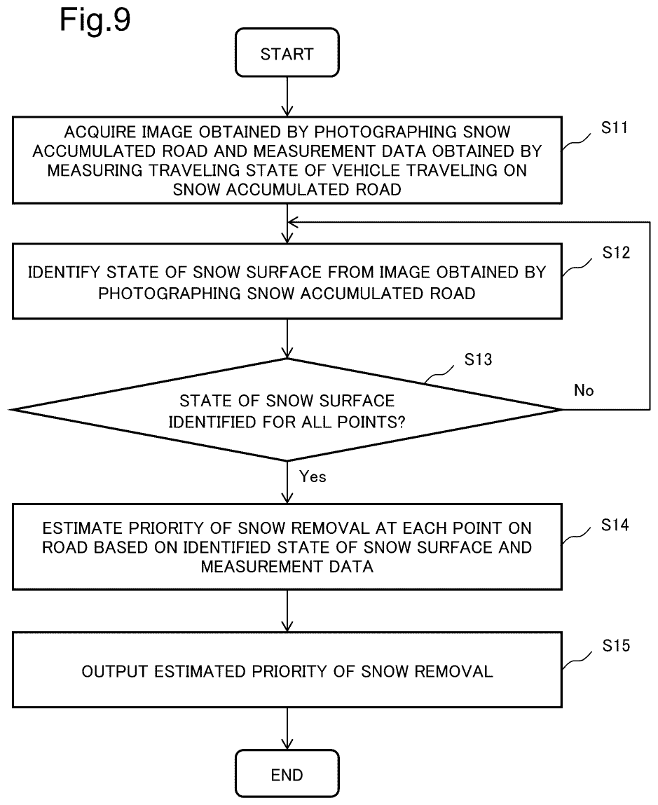

An operation when the snow removal support system 10 estimates the priority of snow removal will be described. FIG. 9 illustrates an example of an operation flow when the snow removal support system 10 estimates the priority of snow removal.

The acquisition unit 11 acquires an image obtained by photographing a snow accumulated road and measurement data obtained by measuring a traveling state of a vehicle traveling on the snow accumulated road (step S11).

When the image obtained by photographing the snow accumulated road and the measurement data are acquired, the identification unit 12 identifies the state of the snow surface from the image obtained by photographing the snow accumulated road (step S12).

When there is a point where the identification of the state of the snow surface has not been completed (No in step S13), the identification unit 12 identifies the state of the snow surface for the image in which the identification of the state of the snow surface has not been completed in step S12.

When the identification of the state of the snow surface has been completed for all the target points (Yes in step S13), the estimation unit 13 estimates the priority of snow removal at each point along the road based on the identified state of the snow surface and the measurement data (step S14).

When the priority of snow removal of the road is estimated, the output unit 14 outputs the priority of snow removal estimated by the estimation unit 13 (step S15). The output unit 14 outputs, for example, the estimation result of the priority of snow removal to the terminal device 30. When the estimation result of the priority of snow removal is acquired, the terminal device 30 outputs the acquired estimation result of the priority of snow removal to, for example, a display device (not illustrated).

The snow removal support system 10 of the present example embodiment identifies the state of the snow surface from the image obtained by photographing the snow accumulated road. Then, the snow removal support system 10 estimates the priority of snow removal of the road based on the identified state of the snow surface and the measurement data obtained by measuring the traveling state of the vehicle. Therefore, a portion where snow removal is necessary can be easily determined by using the snow removal support system 10. In addition, since the snow removal support system 10 estimates the priority of snow removal based on the state of the snow surface and the measurement data obtained by measuring the traveling state of the vehicle, the priority of snow removal can be estimated in consideration of the influence of the snow surface of the road on the traveling of the vehicle.

In addition, when the priority of snow removal is estimated by further using the importance of the road, the priority of snow removal can be estimated in consideration of the influence on traffic. Therefore, the influence of snow accumulation on traffic can be suppressed by performing snow removal with reference to the priority of snow removal estimated by further using the importance of the road.

Furthermore, in a case where the priority of snow removal is estimated by further using weather information, for example, the priority of snow removal can be estimated based on a change in the state of the snow surface that can occur after the time of estimation. Therefore, the effect of snow removal when actually performing snow removal is improved by referring to the priority of snow removal estimated by further using the weather information.

In addition, when the estimation result of the priority of snow removal and the estimation reason are output, for example, the manager of the road can interpret the estimation result of the priority of snow removal with reference to the estimation reason. Therefore, for example, a more appropriate snow removal route can be set, by outputting the estimation result of the priority of snow removal and the estimation reason.

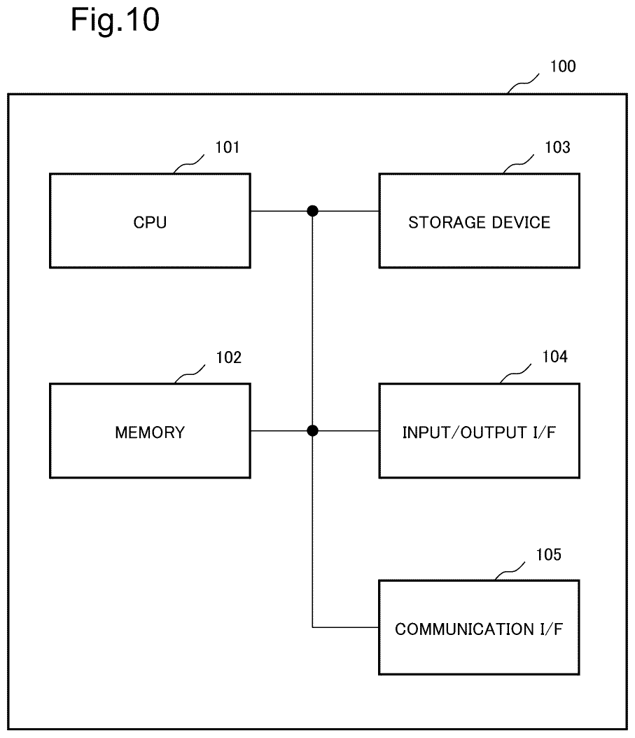

Each process in the snow removal support system 10 can be achieved by executing a computer program on a computer. FIG. 10 illustrates an example of a configuration of a computer 100 that executes a computer program for performing each process in the snow removal support system 10. The computer 100 includes a central processing unit (CPU) 101, a memory 102, a storage device 103, an input/output interface (I/F) 104, and a communication I/F 105.

The CPU 101 reads and executes a computer program for performing each process from the storage device 103. The CPU 101 may be configured by a combination of a plurality of CPUs. The CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program to be executed by the CPU 101 and data being processed. The storage device 103 stores a computer program to be executed by the CPU 101. The storage device 103 includes, for example, a nonvolatile semiconductor storage device. As the storage device 103, another storage device such as a hard disk drive may be used. The input/output I/F 104 is an interface for receiving an input from an operator and outputting display data and the like. The communication I/F 105 is an interface for transmitting and receiving data to and from the in-vehicle device 20, the terminal device 30, and other information processing devices. Furthermore, the terminal device 30 may have a configuration similar to that of the computer 100.

The computer program used for executing each process can also be distributed by being stored in a computer-readable recording medium that non-transiently records data. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as a recording medium.

Some or all of the above example embodiments may be described as the following supplementary notes, but are not limited to the following.

### Supplementary Note 1

A snow removal support system including:
an acquisition means for acquiring an image obtained by photographing a snow accumulated road and measurement data obtained by measuring a traveling state of a vehicle traveling on the snow accumulated road,
an identification means for identifying a state of a snow surface from the image obtained by photographing the snow accumulated road,
an estimation means for estimating a priority of snow removal at each point along a road based on the identified state of the snow surface and the measurement data, and
an output means for outputting the estimated priority of snow removal.

### Supplementary Note 2

The snow removal support system according to supplementary note 1, in which
the estimation means estimates the priority of snow removal based on a state of a rut on the snow surface identified by the identification means.

### Supplementary Note 3

The snow removal support system according to supplementary note 1 or 2, in which
the estimation means estimates the priority of snow removal based on measurement data obtained by measuring acceleration of a vehicle traveling on the snow accumulated road.

### Supplementary Note 4

The snow removal support system according to any one of supplementary notes 1 to 3, in which
the estimation means predicts a state of a snow surface by further using data of weather forecast, and estimates the priority of snow removal based on a result of the prediction.

### Supplementary Note 5

The snow removal support system according to any one of supplementary notes 1 to 4, in which
the estimation means estimates the priority of snow removal by further using a road surface state when there is no snow accumulation.

### Supplementary Note 6

The snow removal support system according to supplementary note 5, in which
the estimation means estimates the priority of snow removal by further using a deterioration degree of a road surface diagnosed when there is no snow accumulation.

### Supplementary Note 7

The snow removal support system according to any one of supplementary notes 1 to 6, in which
the estimation means estimates the priority of snow removal using a score based on the state of the snow surface and a score based on the measurement data.

### Supplementary Note 8

The snow removal support system according to any one of supplementary notes 1 to 6, in which
the estimation means estimates the priority of snow removal using an estimation model for estimating the priority of snow removal based on the state of the snow surface and the measurement data.

### Supplementary Note 9

The snow removal support system according to any one of supplementary notes 1 to 8, in which
the estimation means estimates the priority of snow removal by further using at least one of importance of a road, information regarding a topography, information regarding a structure of a road, or information regarding surrounding facilities.

### Supplementary Note 10

The snow removal support system according to any one of supplementary notes 1 to 9, in which
the output means superimposes and outputs the estimated priority of snow removal and a reason for the estimation on a map.

### Supplementary Note 11

The snow removal support system according to any one of supplementary notes 1 to 10, in which
the acquisition means acquires information in which a range for estimating the priority of snow removal is selected on the map, and
the estimation means estimates the priority of snow removal within the selected range.

### Supplementary Note 12

A snow removal support method including:
acquiring an image obtained by photographing a snow accumulated road and measurement data obtained by measuring a traveling state of a vehicle traveling on the snow accumulated road,
identifying a state of a snow surface from the image obtained by photographing the snow accumulated road,
estimating a priority of snow removal at each point along a road based on the identified state of the snow surface and the measurement data, and
outputting the estimated priority of snow removal.

### Supplementary Note 13

A non-transitory recording medium for recording a snow removal support program for causing a computer to execute:
a process of acquiring an image obtained by photographing a snow accumulated road and measurement data obtained by measuring a traveling state of a vehicle traveling on the snow accumulated road,
a process of identifying a state of a snow surface from the image obtained by photographing the snow accumulated road,
a process of estimating a priority of snow removal at each point along a road based on the identified state of the snow surface and the measurement data, and
a process of outputting the estimated priority of snow removal.

The present invention has been described above by taking the above-described example embodiment as an example. However, the present invention is not limited to the above-described example embodiments. That is, the present invention can apply various aspects that can be understood by those skilled in the art within the scope of the present invention.

### REFERENCE SIGNS LIST

10 snow removal support system
11 acquisition unit
12 identification unit
13 estimation unit
14 output unit
15 storage unit
20 in-vehicle device
30 terminal device
100 computer
101 CPU
102 memory
103 storage device
104 input/output I/F
105 communication I/F

What is claimed is:

1. A snow removal support system comprising:
at least one memory storing instructions; and
at least one processor configured to access the at least one memory and execute the instructions to:
acquire an image obtained by photographing a snow accumulated road and measurement data obtained by measuring a traveling state of a vehicle traveling on the snow accumulated road;
identify a state of a snow surface from the image obtained by photographing the snow accumulated road;
estimate a priority of snow removal at each point along a road based on the identified state of the snow surface and the measurement data; and
output the estimated priority of snow removal.

2. The snow removal support system according to claim 1, wherein
the at least one processor is further configured to execute the instructions to:
estimate the priority of snow removal based on a state of a rut on the identified snow surface.

3. The snow removal support system according to claim 1, wherein
the at least one processor is further configured to execute the instructions to:
estimate the priority of snow removal based on measurement data obtained by measuring acceleration of a vehicle traveling on the snow accumulated road.

4. The snow removal support system according to claim 1, wherein
the at least one processor is further configured to execute the instructions to:
predict a state of a snow surface by further using data of weather forecast; and
estimate the priority of snow removal based on a result of the prediction.

5. The snow removal support system according to claim 1, wherein
the at least one processor is further configured to execute the instructions to:
estimate the priority of snow removal by further using a road surface state when there is no snow accumulation.

6. The snow removal support system according to claim 5, wherein
the at least one processor is further configured to execute the instructions to:
estimate the priority of snow removal by further using a deterioration degree of a road surface diagnosed when there is no snow accumulation.

7. The snow removal support system according to claim 1, wherein
the at least one processor is further configured to execute the instructions to:
estimate the priority of snow removal using a score based on the state of the snow surface and a score based on the measurement data.

8. The snow removal support system according to claim 1, wherein
the at least one processor is further configured to execute the instructions to:
estimate the priority of snow removal using an estimation model for estimating the priority of snow removal based on the state of the snow surface and the measurement data.

9. The snow removal support system according to claim 1, wherein
estimate the priority of snow removal by further using at least one of importance of a road, information regarding a topography, information regarding a structure of a road, or information regarding surrounding facilities.

10. The snow removal support system according claim 1, wherein
the at least one processor is further configured to execute the instructions to:
output map on which the estimated priority of snow removal and a reason for the estimation are superimposed.

11. The snow removal support system according to claim 1, wherein
the at least one processor is further configured to execute the instructions to:
acquire information in which a range for estimating the priority of snow removal is selected on the map, and
estimate the priority of snow removal within the selected range.

12. A snow removal support method comprising:
acquiring an image obtained by photographing a snow accumulated road and measurement data obtained by measuring a traveling state of a vehicle traveling on the snow accumulated road;
identifying a state of a snow surface from the image obtained by photographing the snow accumulated road;
estimating a priority of snow removal at each point along a road based on the identified state of the snow surface and the measurement data; and
outputting the estimated priority of snow removal.

13. A non-transitory recording medium for recording a snow removal support program for causing a computer to execute:
a process of acquiring an image obtained by photographing a snow accumulated road and measurement data obtained by measuring a traveling state of a vehicle traveling on the snow accumulated road;
a process of identifying a state of a snow surface from the image obtained by photographing the snow accumulated road;
a process of estimating a priority of snow removal at each point along a road based on the identified state of the snow surface and the measurement data; and
a process of outputting the estimated priority of snow removal.

14. The snow removal support system according to claim 1, wherein
the at least one processor is further configured to execute the instructions to:
output, to a terminal device, a screen for selection of a range for estimating the priority of snow removal;
acquire information in which the range for estimating the priority of snow removal is selected by an operator on the screen which is displayed on a display of the terminal device;
estimate the priority of snow removal within the selected range based on the acquired information; and
output, to the terminal device, the estimated priority of snow removal.
